(19) United States
(12) Patent Application Publication
(10) Pub. No.: US 2013/0082207 A1
(43) Pub. Date: Apr. 4, 2013

(54) CORE-SHELL PHOSPHOR AND METHOD OF MAKING THE SAME

(71) Applicants: Alok Mani Srivastava, Niskayuna, NY (US); Holly Ann Comanzo, Niskayuna, NY (US); Samuel Joseph Camardello, Albany, NY (US); Florencio Garcia, Schenectady, NY (US)

(72) Inventors: Alok Mani Srivastava, Niskayuna, NY (US); Holly Ann Comanzo, Niskayuna, NY (US); Samuel Joseph Camardello, Albany, NY (US); Florencio Garcia, Schenectady, NY (US)

(73) Assignee: GENERAL ELECTRIC COMPANY, SCHENECTADY, NY (US)

(21) Appl. No.: 13/248,594

(22) Filed: Sep. 29, 2011

(51) Int. Cl. C09K 11/78

(52) U.S. Cl. 252/301.4 R

(57) ABSTRACT

In accordance with one aspect of the present invention, a core−shell phosphor composition is provided that includes a core comprising magnesium oxide; and a shell at least partially enclosing the core, wherein the shell comprises a shell material having formula (I)

(Y₁₋ₓEuₓ)₂O₃ (I)

wherein, 0<x<0.95. In accordance to another aspect of the invention a method of making the core−shell phosphor and a light source including the core−shell phosphor are provided.

### BACKGROUND

The invention generally relates to a core−shell phosphor. More particularly, the invention relates to a core−shell phosphor composition and a method for making the core−shell phosphor.

Green light-emitting phosphates of lanthanum and/or cerium, doped with terbium (at times referred to as “LAP” phosphors), and red light-emitting oxides of yttrium and europium (also known as “YEO” phosphors) are well-known phosphor compositions. A YEO phosphor composition is known as a “red” phosphor as it emits a red light when it is irradiated by certain high-energy radiation having wavelengths below the visible range. This property is advantageously used on an industrial scale, for example, in trichromatic fluorescent lamps, backlighting systems for liquid crystal displays and in plasma systems.

Various synthesis methods have been developed to maximize the efficiency of YEO phosphor. Some of the synthesis methods improve crystallinity of the phosphor thereby enhancing the efficiency. Some other synthesis methods optimize the particle size distribution and morphology of phosphor particles in order to get a uniform coating during lamp coating.

However, a problem still unaddressed is of their particularly high cost, linked especially to the use of rare earths such as yttrium and europium. Hence, it is desirable to develop core−shell phosphors to meet the existing need for inexpensive, high quality phosphors. Coating of relatively inexpensive core with expensive shell materials can help lower the cost of phosphor as well as the cost of manufacturing fluorescent lamps.

### BRIEF DESCRIPTION

In accordance with one aspect of the present invention, a core−shell phosphor composition is provided that includes a core comprising magnesium oxide; and a shell at least partially enclosing the core, wherein the shell comprises a shell material having formula (I)

(Y₁₋ₓEuₓ)₂O₃ (I)

wherein, 0<x<0.95.

In accordance with another aspect, the present invention provides a method of making a core−shell phosphor. The method includes the steps of (a) mixing the core material comprising magnesium oxide, with a shell precursor mixture comprising at least one compound of yttrium, and at least one compound of europium, to form a core+shell precursor mixture; (b) heating the core+shell precursor mixture to a temperature in a range from about 800° C. to about 1400° C. with an inorganic flux to provide a heated core+shell precursor mixture; (c) cooling the heated core+shell precursor mixture to ambient temperature to provide a product core−shell phosphor dispersed in the inorganic flux material; and (d) separating the product core−shell phosphor from the inorganic flux material.

In accordance with one aspect of the present invention, a core−shell phosphor composition is provided that includes a core consisting essentially of magnesium oxide; and a shell at least partially enclosing the core, wherein the shell comprises a shell material having formula (I)

(Y₁₋ₓEuₓ)₂O₃ (I)

wherein, 0<x<0.95.

In accordance with one aspect of the present invention, a core−shell phosphor composition is provided that includes a core comprising magnesium oxide; and a shell at least partially enclosing the core, wherein the shell comprises a shell material having formula (II)

(Y_{1-x-y}A_{y}Euₓ)₂O₃ (II)

wherein A is at least one selected from the group consisting of gadolinium, lanthanum, scandium, lutetium, and terbium; x is in a range from about 0.05 to 0.50; y is in a range from about 0.05 to about 0.7; and (x+y) is less than about 1.

In accordance with yet another aspect, the present invention provides a light source comprising a core−shell phosphor. The core−shell phosphor composition includes a core comprising magnesium oxide; and a shell at least partially enclosing the core, wherein the shell comprises a shell material having formula (I)

(Y₁₋ₓEuₓ)₂O₃ (I)

wherein, 0<x<0.95.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the term “longest dimension” refers to the longest Euclidean distance between two points in a particle. For example, if the particle is spherical, the diameter is the longest dimension of the particle. For an elliptical particle, the longest dimension is the major axis of the ellipse. In hydrated form, the longest dimension of a spherical particle may be the mean or average hydrodynamic diameter of the particle. Similarly, a phosphor particle having a dimension of 1 μm refers to a phosphor particle that has a longest dimension of at least 1 μm. For a phosphor particle of irregular geometry, the size of the particle may be described in terms of its dimension, the longest Euclidean distance between two points in the particle.

As discussed in detail below, embodiments of the present invention include a core−shell phosphor composition that includes a core comprising magnesium oxide; and a shell at least partially enclosing the core, wherein the shell comprises a shell material having formula (I)

(Y₁₋ₓEuₓ)₂O₃ (I)

wherein, 0<x<0.95.

As noted, the core provided by the present invention comprises magnesium oxide. In one embodiment, the core comprises greater than 90 weight percent magnesium oxide. In another embodiment, the core consists essentially of magnesium oxide. In yet another embodiment, the core comprises in a range from about 95 weight percent to about 100 weight percent of magnesium oxide. In some example embodiments the core may further include at least one compound of aluminum, gallium, calcium, magnesium, zinc and boron which is a temperature-stable material. As used herein, the term “temperature stable material” refers to a material having a melting point at high temperature, and the material does not degrade into a by-product affecting the application, for example an application of phosphor, at the same temperature. The material remains crystalline without converting into an amorphous material at the same temperature. The high temperature proposed here is a temperature of at least greater than 900° C., particularly at least greater than 1000° C. In some embodiments, the core may comprise trace amounts of one or more rare earth metals, such as lanthanum, cerium, terbium, gadolinium, scandium, lutetium, yttrium, or combinations thereof. In one embodiment, the core may be substantially free of yttrium. In another embodiment, the core may contain less than about 1000 ppm of yttrium.

Typically, the core is at least partially enclosed by a shell. In various embodiments, on the surface of the core, a layer or shell based on a material of mixed yttrium and europium oxide may be deposited. The deposited material is known as a shell, which is made of a mixed phosphor of yttrium and europium, and which at least partially encloses the core. In another embodiment, the shell is a homogeneous layer of a mixed phosphor that coherently crystallizes on the core. As used herein, the term “homogeneous layer” refers to a continuous layer, completely covering the core, and the homogeneity is clearly visible on scanning electron micrographs. The material of the layer has a homogeneous distribution.

The shell comprises a shell material having formula (I)

(Y₁₋ₓEuₓ)₂O₃ (I)

wherein, 0<x<0.95. In one embodiment, the value of x is in a range from about 0.01 to about 0.90. In certain embodiments, for the shell of formula (I), the value of x is in a range from about 0.1 to about 0.5. In certain specific embodiments, for the shell of formula (I), the value of x is in a range from about greater than 0 to about 0.5 (0<x≦0.5). In one embodiment, the shell material further comprises at least one rare earth metal selected from the group consisting of gadolinium, lanthanum, lutetium, scandium, and terbium. In one embodiment, the shell material further comprises gadolinium. In another embodiment, the shell material further comprises lanthanum. In one embodiment, x is between 0.01 and 0.3. In another embodiment, x is between 0.01 and 0.5.

In another embodiment, the shell comprises a shell material having formula (II)

(Y_{1-x-y}A_{y}Euₓ)₂O₃ (II)

wherein A is at least one selected from the group consisting of gadolinium, lutetium, lanthanum, scandium and terbium; x is in a range from about 0.01 to 0.50; y is in a range from about 0.01 to about 0.7; and (x+y) is less than about 1. In one embodiment, the shell material further comprises gadolinium. In another embodiment, the shell material further comprises lanthanum.

In one embodiment, an atom percent of yttrium in the shell is in a range from about 2% to about 98%. In another embodiment, an atom percent of yttrium in the shell is in a range from about 5% to about 90%. In one embodiment, an atom percent of europium in the shell is in a range from about 1% to about 98%. In another embodiment, an atom percent of europium in the shell is in a range from about 20% to about 85%. In another non-limiting example, the shell composition consists essentially of (Y_{0.95}Eu_{0.5})₂O₃.

The shell material (Y, Eu)₂O₃ may further comprise other compounds, for example, polyphosphates of rare-earth metals, generally in a minor amount that does not exceed about 5%. According to one particular embodiment, the mixed phosphate, which crystallizes on the core may comprise one or more elements other than yttrium, or europium, where the elements conventionally have a role, in particular, of promoting the luminescence properties or of stabilizing the degrees of oxidation of yttrium and europium. These additional elements may include, for example, alkali metals (Li, Na, K, in particular), and boron.

The core−shell phosphor provided by the present invention comprises a particulate structure. The core−shell phosphor particle may comprise a regular geometry or an irregular geometry. The core−shell phosphor particle may be of various shapes, such as spherical, elliptical, or cubical. The dimensions of the core, shell, and the core−shell particle may especially be measured from scanning electron micrographs of sections of core or shell or core−shell particle.

In some embodiments, the core−shell of the present invention comprises a particulate structure with a longest dimension in a range from about 0.2 μm to about 20 μm. In some embodiments, the core−shell of the present invention comprises a particulate structure with a longest dimension in a range from about 0.5 μm to about 10 μm. In one embodiment, the core−shell phosphor may have a shell of thickness in a range from about 800 nm to 5 μm, in a range from about 500 nm to about 4 μm. In another embodiment, the core−shell phosphor may have a core of thickness in a range from about 0.5 μm to 5 μm. In some embodiments, the core−shell phosphor may have a core having a particulate structure with a longest dimension in a range from about 0.2 μm to about 5 μm.

In certain embodiments, the core−shell phosphor particle may have a longest dimension in a range from about 0.5 μm to about 20 μm. In one embodiment, the core−shell phosphor may have a longest dimension between 1.5 μm and 15 μm. In some embodiments, the core−shell phosphor product may be milled by using ⅛ inch yttria stabilized zirconia (YSZ) media in water in order to break any agglomerates of particle formed and get the desired particle size. This milling may be done for 1-60 minutes as per requirement.

The luminescence property of a phosphor may be quantified by the conversion yield of the phosphor, which corresponds to a ratio of the number of photons emitted by a phosphor to the number of photons absorbed from the excitation beam. The conversion yield of a phosphor is evaluated by measuring, in the visible range of the electromagnetic spectrum, the emission of a phosphor under an excitation in the UV or VUV range generally at a wavelength below 280 nm The value of the brightness obtained for the core−shell phosphor, at emission intensity integrated between 400 and 700 nm, is then compared with that of a reference phosphor. The core−shell phosphor provided by the present invention has intense red luminescence property for electromagnetic excitations corresponding to the various absorption fields of the product. The core−shell phosphor has a strong red emission under VUV excitation, due to strong absorption at these wavelengths by the shell phosphor. Thus, the core−shell phosphor may be used in lighting or display systems having an excitation source in the UV range (200-350 nm), for example around 254 nm.

The core−shell phosphor may be used in UV excitation devices, such as in trichromatic lamps, especially in mercury vapor trichromatic lamps, lamps for backlighting liquid crystal systems, plasma screens, xenon excitation lamps, devices for excitation by light-emitting diodes (LEDs), fluorescent lamps, cathode ray tube, plasma display device, liquid crystal display (LCD), and UV excitation marking systems. The core−shell phosphor may also be used as a scintillator in an electromagnetic calorimeter, in a gamma ray camera, in a computed tomography scanner or in a laser. These uses are meant to be merely exemplary and not exhaustive.

In one embodiment, the present invention provides a method of making a core−shell phosphor. The method includes the steps of (a) mixing a core material comprising magnesium oxide with a shell precursor mixture comprising at least one compound of yttrium, and at least one compound of europium to form a core+shell precursor mixture; (b) heating the core+shell precursor mixture to a temperature in a range from about 800° C. to about 1400° C. with an inorganic flux material to provide a heated core+shell precursor mixture; (c) cooling the heated core+shell precursor mixture to ambient temperature to provide a product core−shell phosphor dispersed in the inorganic flux material; and (d) separating the product core−shell phosphor from the inorganic flux material.

Typically at least one compound of yttrium, and at least one compound of europium are used to make the shell. In one embodiment, the shell precursor mixture may include starting materials for example, elemental oxides, nitrates, phosphates, carbonates, and/or hydroxides. Other starting materials may include, but are not limited to, sulfates, acetates, citrates, or oxalates. Alternately, co-precipitates or double salts of one or more of rare earth compounds may also be used as the starting materials. As noted, the compound of yttrium and compound of europium, are independently at each occurrence, selected from oxides, nitrates, carbonates, acetates, and combinations thereof. For a non-limiting example, compound of Y may be selected from an acetate, such as yttrium-acetate, wherein the compound of europium may be selected from nitrates, such as europium-nitrate and vice-versa. In another non-limiting example, compound of yttrium may be selected from carbonates, such as yttrium carbonate, wherein the compound of europium may be selected from an oxalate, such as europium oxalate. In another embodiment, the shell precursor mixture comprises at least one compound of yttrium, and at least one compound of europium, which are selected from phosphates, such as, yttrium-phosphate, or europium-phosphate. In yet another embodiment, the shell precursor mixture may comprise a mixed oxide of yttrium and europium. In one embodiment, the shell precursor mixture further comprises at least one compound selected from a group consisting of a compound of gadolinium, a compound of lanthanum, a compound of scandium, a compound of terbium, and a compound of lutetium. The shell precursor mixture may be mixed with the core comprising magnesium oxide along with fluxes and heated at a predetermined temperature that is usually between 900° C. and 1400 C to form core−shell phosphor.

In one embodiment, the core−shell phosphor is made employing a molten salt method where the starting materials may be milled down to micron-sized powders and then dispersed in an inorganic flux material and mixed thoroughly by shaking in a Nalgene bottle. The mixture of reactants and flux materials may be dispensed into an alumina crucible under vigorous mixing. The starting materials may be mixed together by any mechanical method including, but is not limited to, stirring or blending in a high-speed blender or a ribbon blender. In a typical process, the starting materials may be combined via a dry blending process. The starting materials may be combined and pulverized together in a bowl mill, a hammer mill, or a jet mill.

In one embodiment, the inorganic flux material may be added to the core+shell precursor mixture prior to or during the mixing step of the reactants. In one embodiment, the inorganic flux material may be selected from one or more of sodium dihydrogen phosphate (NaH₂PO₄), sodium diphosphate (Na₄P₂O₇), sodium tetraborate, lithium tetraborate (Li₂B₄O₇), barium carbonate, borax, boron trioxide (B₂O₃), and boric acid. In another embodiment, the inorganic flux materials may further include any other conventional fluxing agent, such as aluminum trifluoride (AlF₃), ammonium chloride (NH₄Cl). As the formation of the shell is initiated in the presence of a flux material in a molten phase, a minimum temperature is necessary to maintain the molten state of the inorganic fluxes. In one embodiment, the amount of inorganic flux material is less than about 20%, particularly less than about 10% by weight of the total weight of the mixture. Typically, the heating of the core+shell precursor mixture with the inorganic flux material is carried out at a temperature in a range from about 800° C. to about 1400° C. In one embodiment, the heating of the core+shell precursor mixture with the inorganic flux material is carried out at a temperature in a range from about 850° C. to about 1200° C.

In one embodiment, the heating of the core+shell precursor mixture with the inorganic flux material is carried out in presence of air. In another embodiment, the heating of the core+shell precursor mixture with the inorganic flux material is carried out in presence of a reducing agent. Typically, the reducing agent comprises a reducing gas such as hydrogen, carbon monoxide, nitrogen, charcoal, or combinations thereof. The reducing agent is optionally diluted with an inert gas, such as nitrogen or Argon, or combinations thereof. In a specific embodiment, the reducing agent may comprise hydrogen, nitrogen, or combinations thereof. In one embodiment, to produce a carbon monoxide atmosphere, the crucible containing the core−shell mixture may be packed in a second closed crucible containing high-purity carbon particles and fired in air so that the carbon particles react with the oxygen present in the air, thereby generating carbon monoxide and providing a reducing atmosphere.

For core−shell phosphors, a homogeneous shell material may be formed after firing the core+shell precursor mixture between about 900° C. and about 950° C. under a reducing atmosphere (e.g. 1% H₂ in N₂). The dried core−shell mixture may be fired under a reducing atmosphere at a temperature from about 900° C. to about 1200° C., or from about 1000° C. to about 1600° C., for a time sufficient to convert all of the mixture to the final composition. As noted, the heating or firing of the core−shell mixture may be conducted in an alumina crucible using a tube furnace. The heating or firing may be conducted in a batch wise or continuous process, with a stirring or mixing action to promote adequate gas-solid contact. The firing time depends on the quantity of the mixture to be fired, the rate of gas conducted through the firing equipment, and the quality of the gas-solid contact in the firing equipment. Typically, a firing time of about 1 hour under a reducing atmosphere is adequate for maximum turnover of reactant to product. In one embodiment, a combination of fluxes may be chosen in a way to tune the solubility of (Y,Eu)₂O₃ in order to obtain core−shell phosphor at the desired synthesis temperature.

In one embodiment, upon cooling of the heated core+shell precursor mixture to ambient temperature, the shell phosphor containing the activators present in the flux material is epitaxially deposited on the core. In a molten state of the reaction mixture, some of the reactants may be trapped in the molten flux materials. Upon cooling of the heated core−shell mixture to ambient temperature, the trapped reactants may be extracted out from the flux materials and further deposited on the core. In one embodiment, the ambient temperature may include room temperature. The product core−shell phosphor is dispersed in the inorganic flux materials, and the dispersed product is then separated from the inorganic flux materials by washing with hot water and hot dilute acid. The filtered core−shell phosphor is washed with deionized water, and dried for a sufficient time, may be for overnight, in an oven to obtain the desired phosphor composition.

### EXAMPLES

### Example 1

### Synthesis of Core-Shell Phosphor ((Y,Eu)₂O₃ Shell on MgO Core)

The core−shell phosphor with YEO on MgO powder was synthesized by a high temperature solid-state reaction in accordance with one embodiment of the invention. YEO precursor doped with about 5 percent europium obtained by oxalate precipitation (77.78 g), and magnesium oxide (22.22 g) were blended in a 500 ml Nalgene bottle along with barium octaborate BaB₈O₁₃ (0.1595 g) as a flux material. The BaB₈O₁₃ was added in the form of barium carbonate and boron trioxide. The reaction mixture was ball milled with 25¼″ zirconia media and 10½″ zirconia media for a duration of five hours. The milled powder was transferred to an alumina crucible and fired in a furnace at a temperature of 1260° C. for 6 hours in air. At the end of the stipulated time the product thus obtained was ground in a mortar and pestle and sieved through a 60 mesh sieve. The as-sieved powder was washed in hot H₂O (2×). The washed powder was then ultrasonicated for 30 minutes to further break up agglomerates. The powder was then wet sieved through a 325 mesh screen and filtered and dried to obtain the final product.

### Characterization of Core-Shell Phosphor Particles:

The core−shell phosphor particles prepared were characterized by measuring particle size, morphology, and phase formation.

### Core-Shell Phosphor Particle Size Measurement:

Particle size (particle diameter) of core−shell phosphor samples prepared as described above were first subjected to a pre-analysis preparation step and then subjected to particle size analysis according to the following protocol. The phosphor samples were dispersed in water to form a suspension, and the suspension was subjected to ultrasound treatment (130 W) for 45 seconds. Ultrasound treatment improves the dispersion of the phosphor samples by deagglomeration and increases the uniformity of particle sizes. The particle diameter was measured using a laser particle size analyzer (Malvern Mastersizer 2000-Hydro 200S). The particle diameters were in a range from about 1 μm to about 15 μm.

### Core Shell Phosphor Crystal Structure:

The powder X-ray diffraction patterns were obtained using PANalytical diffractometer with Cu—K_{α} radiation in Bragg-Brentano geometry. The X-ray diffraction study was performed using the K_{α} line with copper (Cu) as an anticathode according to the Bragg-Brentano method. The core−shell phosphor particles were sieved through 325 mesh prior to the X-ray diffraction study. The X-ray diffraction patterns of the core−shell phosphor were compared with the reference phosphor. The core−shell phosphor showed uniform phase distribution with cubic Y₂O₃ structure.

### Quantum Efficiency Measurements:

Quantum efficiency and absorption measurements were carried out on the product core−shell phosphor powder. The product powder was pressed in an aluminum plaque and spectra were recorded using a SPEX Flouorlog double spectrometer against a known internal standard.

The quantum efficiency (QE) determined for the product core−shell phosphor was found to be from 98 to 100% percent in comparison with that of the commercially available phosphor employed as a standard and the absorbance (ABS) was 74. The product core−shell phosphor was also tested in linear fluorescent lamp (LFL) using established protocols and was found to be stable.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A core−shell phosphor composition comprising:
a core comprising magnesium oxide; and
a shell at least partially enclosing the core, wherein the shell comprises a shell material having formula (I)
(Y₁₋ₓEuₓ)₂O₃ (I)
wherein, 0<x<0.95.

2. The composition according to claim 1, wherein the shell material further comprises at least one rare earth metal selected from the group consisting of gadolinium, lanthanum, lutetium, scandium, and terbium.

3. The composition according to claim 1, wherein the shell material further comprises gadolinium.

4. The composition according to claim 1, wherein the shell material further comprises lanthanum.

5. The composition according to claim 1, wherein the shell material consists essentially of (Y_{0.95}Eu_{0.5})₂O₃.

6. The composition according to claim 1, wherein the shell has a thickness in a range from about 800 nm to 5 μm.

7. The composition according to claim 1, wherein the core−shell phosphor has a particulate structure with a longest dimension in a range from about 0.5 μm to about 20 μm.

8. The composition according to claim 1, wherein the core has a thickness in a range from about 0.5 μm to 5 μm.

9. The composition according to claim 1, wherein the core has a particulate structure with a longest dimension in a range from about 0.2 μm to about 15 μm.

10. The composition according to claim 1, wherein the shell substantially encloses the core.

11. The composition according to claim 1, wherein an atom percent of Y in the shell is in a range from about 98% to about 2%.

12. The composition according to claim 1, wherein an atom percent of Eu in the shell is in a range from about 98% to about 1%.

13. The composition according to claim 1, wherein the core comprises greater than 90 weight percent magnesium oxide.

14. A method of making a core−shell phosphor, the method comprising:
(a) mixing the core material comprising magnesium oxide, with a shell precursor mixture comprising at least one compound of yttrium, and at least one compound of europium, to form a core+shell precursor mixture;
(b) heating the core+shell precursor mixture to a temperature in a range from about 800° C. to about 1400° C. with an inorganic flux material to provide a heated core+shell precursor mixture;
(c) cooling the heated core+shell precursor mixture to ambient temperature to provide a product core−shell phosphor dispersed in the inorganic flux material; and
(d) separating the product core−shell phosphor from the inorganic flux material.

15. The method according to claim 14, wherein the compound of yttrium, and the compound of europium, are independently at each occurrence, selected from the group consisting of oxides, nitrates, carbonates, acetates, phosphates, oxalates, and combinations thereof.

16. The method according to claim 14, wherein the shell precursor mixture further comprises at least one compound selected from a group consisting of a compound of gadolinium, a compound of lanthanum, a compound of scandium, a compound of terbium, and a compound of lutetium.

17. The method according to claim 14, wherein the inorganic flux material is a mixture of barium carbonate, boric acid, borax, and lithium tetraborate.

18. The method according to claim 14, further comprising heating the core+shell precursor mixture with an inorganic flux material in presence of a reductant.

19. The method according to claim 14, further comprising heating the core+shell precursor mixture with an inorganic flux material in presence of air.

20. The method according to claim 19, wherein the reductant comprises hydrogen, nitrogen, or charcoal.

21. The method according to claim 20, wherein the reductant is hydrogen.

22. A core−shell phosphor composition comprising:
a core consisting essentially of magnesium oxide; and
a shell at least partially enclosing the core, wherein the shell comprises a shell material having formula (I)
(Y₁₋ₓEuₓ)₂O₃ (I)
wherein, 0<x<0.95.

23. A core−shell phosphor composition comprising:
a core comprising magnesium oxide; and
a shell at least partially enclosing the core, wherein the shell comprises a shell material having formula (II)
(Y_{1-x-y}A_{y}Euₓ)₂O₃ (II)
wherein A is at least one selected from the group consisting of gadolinium, lanthanum, scandium, lutetium, and terbium; x is in a range from about 0.05 to 0.50; y is in a range from about 0.05 to about 0.74; and (x+y) is less than about 1.

24. A light source comprising a core−shell phosphor composition comprising:
a core comprising magnesium oxide;
a shell at least partially enclosing the core, wherein the shell comprises a shell material having formula (I)
(Y₁₋ₓEuₓ)₂O₃ (I)
wherein, 0<x<0.95.
